(19) United States
(12) Patent Application Publication
(10) Pub. No.: US 2007/0143298 A1
(43) Pub. Date: Jun. 21, 2007

(54) Browsing items related to email

(75) Inventors: Arungunram C. Surendran, Sammamish, WA (US); John C. Platt, Redmond, WA (US); Bryan T. Starbuck, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/305,399

(22) Filed: Dec. 16, 2005

(51) Int. Cl. G06F 17/30

(52) U.S. Cl. 707/10

(57) ABSTRACT

A system for browsing items related to an email comprises a grouping component that groups items into a plurality of sets of related items. A tagging component associates one or more tags with each of the sets of related items, and an email display component displays an email and one or more tags associated with the displayed email. A related item display component receives a user selection of at least one of the one or more tags and displays one or more items related to the displayed email based at least in part upon the user selection.

### BACKGROUND

Storage capacity on computing devices has increased tremendously over a relatively short period of time, thereby enabling users and businesses to create and store a substantial amount of data. For example, hard drive space on today's consumer computers is in the order of hundreds of gigabytes. Servers and other higher-level devices can be associated with a significantly greater amount of storage space. This growth in storage capacity is not solely limited to personal computers and servers, but rather has reached into the portable device space, such as portable telephones, personal digital assistants, portable media players, and other suitable hand-held devices.

The massive amount of storage space available to average consumers has enabled them to retain thousands if not millions of files. For example, photographs can be taken through use of a digital camera and then transferred and retained on a computing device. Thus, a computing device can effectively be utilized as a photograph album. In a similar vein, music files can be ripped from a media such as a compact disk and placed upon the computing device, thereby enabling the computing device to act as a juke box. Word processing documents can be created and retained, wherein such documents can relate to one's bills, reports, school papers, employment, investment portfolio, etc. Spread sheet files, slide presentations, and other item types relating to any topic desired by the user can also be created and/or retained in a hard disk or memory of a computing device. Given the significant number of data files that may exist on a computing device, wherein such files can be created at different times and relate to different topics, it can be discerned that organization and/or indexing of such files can be extremely problematic.

To undertake data file organization, conventionally folders and sub-folders are created, wherein names and location within a hierarchy of the folders is determined according to topic and content that is to be retained therein. This can be done manually and/or automatically; for instance, a user can manually create a folder, name the folder, and place the folder in a desired location. Thereafter, the user can move data/files to such folder and/or cause newly created data/files to be saved in the folder. Folders can also be created automatically through one or more programs. For example, digital cameras typically store files in folders that are named by date—thus, digital photographs can be stored in a folder that recites a date that photographs therein were taken. This approach works well for a small number of files created over a relatively short time frame, as users can remember locations of folders and contents that were stored therein. When number of files and folders increases and time passes, however, users have difficulty remembering where items that they wish to retrieve are located, what they were named, etc. A search for file content or name can then be employed, but often this search is deficient in locating desired data, as a user may not remember a name of a file, when such file was created, and other parameters that can be searched. To cause even further difficulty, a file may be related to a particular topic, but a search function cannot be employed due to lack of content or lack of particular wording. In a specific example, a user may wish to locate each digital photograph that includes a certain family member, but the only manner to search for photographs may be through file name and date of creation.

To make up for some of these deficiencies, data or files can be associated with additional metadata, hereinafter referred to as tags. For example, a user can tag a photograph with names of individuals who are in such photograph. Thus, upon performing a search for the name of a family member, each file that was tagged with the name can be quickly provided to the user. In an email example, an email can contain content relating to a professor while not including data relating to a university that employs the professor. The user can associated the email with the university by tagging the email with the university name—thus, a subsequent search of emails for the university will result in return of the aforementioned email to a searcher. Tagging in this conventional manner, however, is extremely inefficient, as each item must be manually tagged by a user. In more detail, the user must select one or more items (through multi-select) and then manually create a desired tag. If thousands of items exist, users will become exasperated with the painfully inefficient process of manually tagging items. Automatic tagging of items can also be undertaken, but requires use of a substantial amount of training data, which can be expensive (in terms of time) to obtain.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Systems, methods, articles of manufacture, apparatuses, and the like that can be employed in connection with automatically selecting and providing substantially similar tags to a group of related items is described herein, wherein such tags can be employed in connection with item browsing based upon selection of an email. Items can be analyzed in order to group items that have some sort of relation into one or more sets of related items, wherein the items can include all items associated with a computer, all items in a certain storage location, all items associated with one or more applications, etc. The items can also be of any suitable type, including emails, word processing documents, web pages, spreadsheets, slide show presentations, etc. In one example, item descriptions associated with each item can be generated, wherein the item descriptions can include text and/or metadata associated with each item. Furthermore, an item description can be based at least in part upon tags previously assigned to such item (e.g., a tag assigned to an item by a user).

Items can then be grouped to cause related items to be in substantially similar set(s). In one example, this grouping can be accomplished through utilization of one or more clustering algorithms, wherein the clustering algorithms can consider the aforementioned item descriptions. Any suitable manner of clustering, however, is contemplated and intended to fall under the scope of the hereto-appended claims. In another example, each item can be associated with a “clique” or “neighborhood,” wherein a clique or neighborhood includes an item and k-nearest neighbors to such item. These neighborhoods can then be employed as sets or provided to a clustering algorithm for grouping with other neighborhoods. Furthermore, the relation between items within a set can be any suitable relation. For example, the relation can be based upon time of creation, location that items are stored within a hard drive, similarity of content, application(s) utilized to create items, etc.

Once a set of related items is defined, one or more tags can be associated with the set (e.g., each item within the set of related items can be associated with the one or more tags). The tags can be identified through extraction of text from within an item, analysis of metadata associated with the item, and the like. In a detailed example, text that is somewhat common across items within the set of related items can be employed as tags. Still further, disparate portions of items can weighted, thereby rendering text associated with such portions as more likely to be employed as tags. For instance, text within a subject line of an email may be weighted in a manner so that it is more likely to be employed as a tag than text within a body of an email. After the tagging of items is complete, a search over items that includes words or phrases that were previously assigned as tags can return items within the group of related items. It is understood, however, that items within the group of related items can also include tags provided by a user and/or tags associated with a disparate group.

Further, the tags can be employed to aid users in locating items that are associated with emails. For example, emails within an email application can be considered as items (along with items of other types), and can be within one or more sets of related items. Upon selection or display of an email, tags that are associated with such email can be provided to a user (e.g., as hyperlinks in a display field). In other words, tags associated with each set that includes the displayed/selected email and/or tags associated with each set that is associated with a threshold level of similarity to the email can be provided to the user. Upon selection of one or more of such tags, items that include the tag can be provided to the user. Thus, an efficient and intuitive manner of organizing items based upon emails is described herein.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high-level block diagram of an automatic group tagging and item browsing system.

FIG. 2 is a block diagram of a system that facilitates display of advertisements based at least in part upon tags assigned to items.

FIG. 3 is a system that facilitates automatic group tagging upon receipt of user input.

FIG. 4 is an automatic tagging system that utilizes clustering to define groups of related items.

FIG. 5 illustrates use of text extraction in connection with providing substantially similar tags to multiple items.

FIG. 6 is an automatic group tagging system that can be utilized without aid of training data.

FIG. 7 is a representative flow diagram illustrating a methodology for browsing items based at least in part upon tags automatically associated with the items.

FIG. 8 is a representative flow diagram illustrating a methodology for automatically assigning substantially similar tags to multiple, related items.

FIG. 9 is a representative flow diagram illustrating a methodology for stepping through multiple items and defining a set for each item.

FIG. 10 is a representative flow diagram illustrating a methodology for creating and employing item descriptions in connection with generating group tags.

FIG. 11 is a representative flow diagram illustrating a methodology for grouping items through analysis of tags and keywords associated therewith.

FIG. 12 is a representation of multiple groups that may include substantially similar items.

FIG. 13 illustrates a group of related items, wherein each item within the group of items includes group tags and individual tags.

FIG. 14 is an exemplary user interface that can be employed to search items through use of tags.

FIG. 15 is an exemplary user interface that can be employed to browse items upon display of an email.

FIG. 16 is a schematic block diagram illustrating a suitable operating environment.

FIG. 17 is a schematic block diagram of a sample-computing environment.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

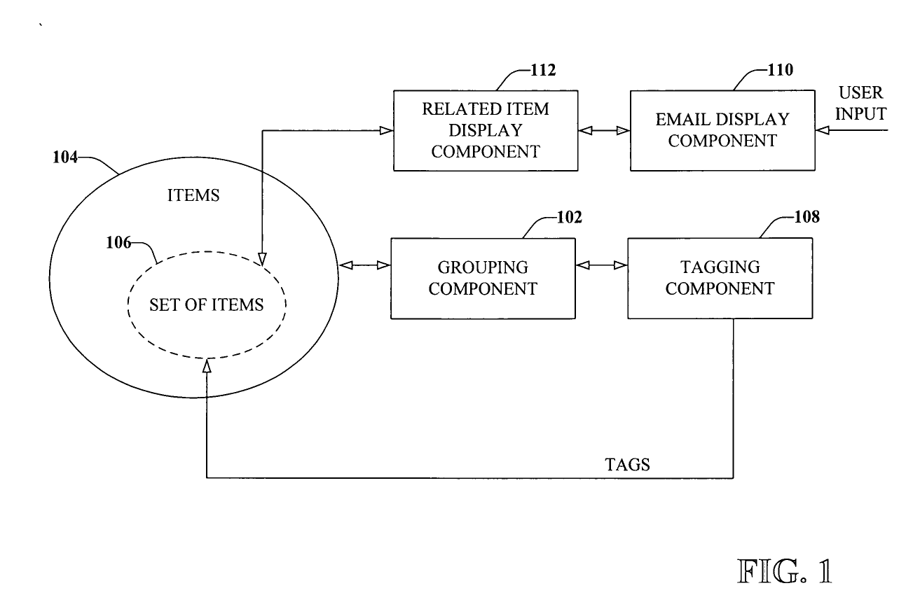

The claimed subject matter will now be described with respect to the drawings, where like numerals represent like elements throughout. Referring now to FIG. 1, a system 100 that facilitates browsing of items based at least in part upon relation to emails is illustrated. The system 100 includes a grouping component 102 that analyzes a plurality of items 104 to define a set of related items 106, wherein the items can be files, such as photographs, word processing files, spreadsheets, etc., as well as web pages, emails, and any other suitable types of data items. The items 104 can include items of a substantially similar type or items of disparate types, and can be restricted based upon desired implementation. For example, the items 104 can include each item resident within a computer, each item within a hard drive, each item within a removable storage media, each item associated with a particular application or set of applications, any combination thereof, etc. At least some of the items 104 can also be related to the Internet or an intranet. For example, a web site may be associated with a particular tag.

The grouping component 102 can define the set of related items 106 through analyzing a first item, for example, and thereafter locating items that are in some way related to the first item. The first item can be selected manually by a user and/or automatically by the grouping component 102 (or other computing component). Upon selection of the first item, the grouping component 102 can determine relationships between the first item and other items within the plurality of items 104 through a variety of means. For instance, the grouping component 102 can analyze pre-existent tags associated with the first item and thereafter locate items that are associated with similar tags (e.g., items that have similar tags, have content that corresponds to the tags, . . . ). In another example, content of the first item can be analyzed and keywords can be created and/or extracted from the first item. These keywords can then be employed to locate items that have some sort of relation to the keywords, and thus have a relation to the first item. In yet another example, relationships can be determined based upon location within a computer, item type, date of creation of items, etc. Accordingly, any suitable manner of creating the set of related items 106 is contemplated and intended to fall under the scope of the hereto-appended claims.

A tagging component 108 that is communicatively coupled to the grouping component 102 can receive an identity of the set of related items 106 (e.g., items within the set of related items 106). Based upon the items within the set of related items 106, the tagging component 108 can automatically provide substantially similar tags to each item within the set of related items 106. For instance, keyword extraction techniques can be undertaken upon each item within the set of related items 106, and a threshold number of keywords that are at least somewhat common across the items within the set of related items 106 can be utilized as tags for each item within the set 106. Thus, in a detailed example, a set of ten items can be defined, wherein the keyword “football” may have been extracted from four of such items. The tagging component 108 can then tag each of the ten items with the keyword “football.” A search for utilizing the term “football” would then result in return of each of the ten items. While the items within the set of related items 106 would each be tagged by the tagging component 108 with substantially similar tags, the items can further include individual tags that were provided by a user.

The system 100 further includes an email display component 110 that displays a plurality of emails (where at least a subset of the emails are amongst the items 104). The email display component 110 can further display one or more tags that were associated with one or more sets of items that include the displayed email. Additionally or alternatively, the email display component 110 can display one or more tags associated with one or more sets of items that are similar to the displayed email. For example, an item can be associated with a similarity score to a set of related items (but not be included within the set of items). If the similarity score between the displayed email and a set of items is within a defined threshold, tags associated with the set can be displayed by the email display component 110. The tags can be displayed as selectable hyperlinks, for example.

The email display component 110 can be associated with a related item display component 112. More particularly, a user can select at least one of the tags displayed by the email display component 110, and the related item display component 112 can provide the user with items that are related to the displayed email in general, and that are associated with the selected tag(s) in particular. For instance, items within set(s) of items that are associated with a tag selected by the user can be provided to such user. These items can include word processing documents, web pages, spreadsheets, digital photographs, and any other suitable item. Thus, through employment of the system 100, a user can quickly and easily locate items related to emails without being forced to manually undertake an association between items and emails.

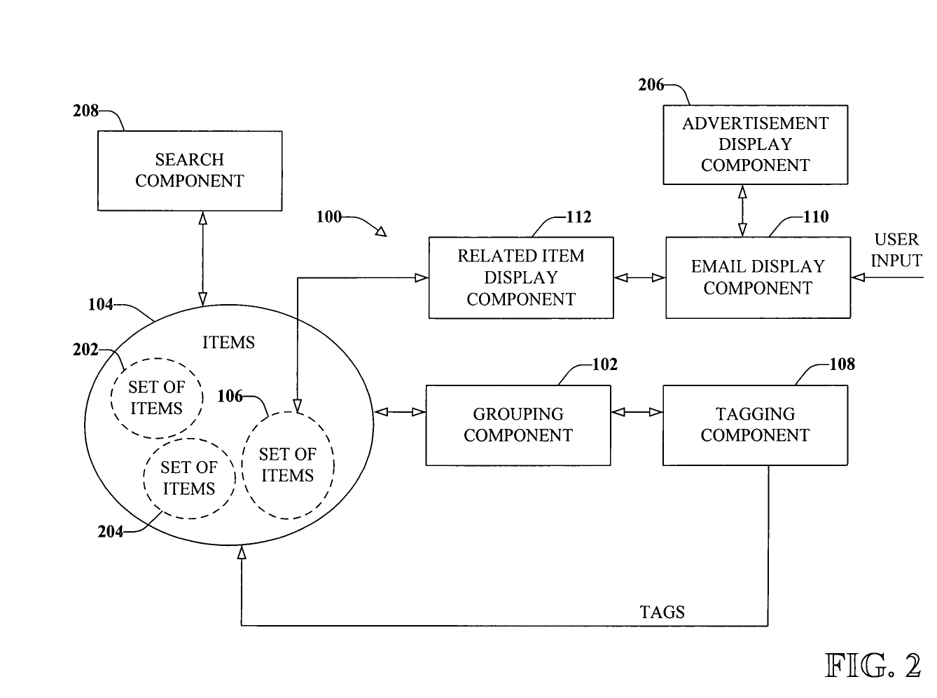

Referring now to FIG. 2, a system 200 that facilitates provision of items based upon relation to such items to an email is illustrated. The system 200 includes the grouping component 102 that analyzes the items 104 and defines the set of items 106 based at least in part upon the analysis. The grouping component can also define sets of items 202 and 204, wherein items can be included within multiple sets. Furthermore, items can be provided a similarity score with respect to sets of items—thus, even if a set does not include a particular item, the item can be related to the set. The tagging component 108 can then provide at least one tag to each of the sets of items 106, 202, and 204.

The email display component 110 can display an email as well as tags that are associated with such email (e.g., tags associated with sets that include the email and/or that are of sufficient similarity to the email). An advertisement display component 206 can then automatically provide one or more advertisements to the user based at least in part upon the tags that are displayed by the email display component. For instance, at least one of the tags can be related to automobiles, and thus the advertisement display component 206 can provide automobile advertisements to the user. As described above, upon the user selecting at least one tag, the related item display component 112 can provide items that are within sets (or significantly similar to sets) associated with such tag(s). In another example, the advertisement display component 206 can provide advertisements upon the user selecting a tag, thereby enabling provision of most relevant advertisements to the user.

The system 200 can further include a search component 208 that enables items within the plurality of items 104 to be searched based upon tags associated therewith. For instance, the search component 208 can receive a query, which may be a word, a phrase, and/or a plurality of words/phrases. The search component 208 can analyze tags associated with the items 104 and provide a generator of the query with results based upon the query and the tags. The search component 208 can require an exact match to one or more tags from the query, a partial match, or any other suitable manner for searching through items based upon associated tags.

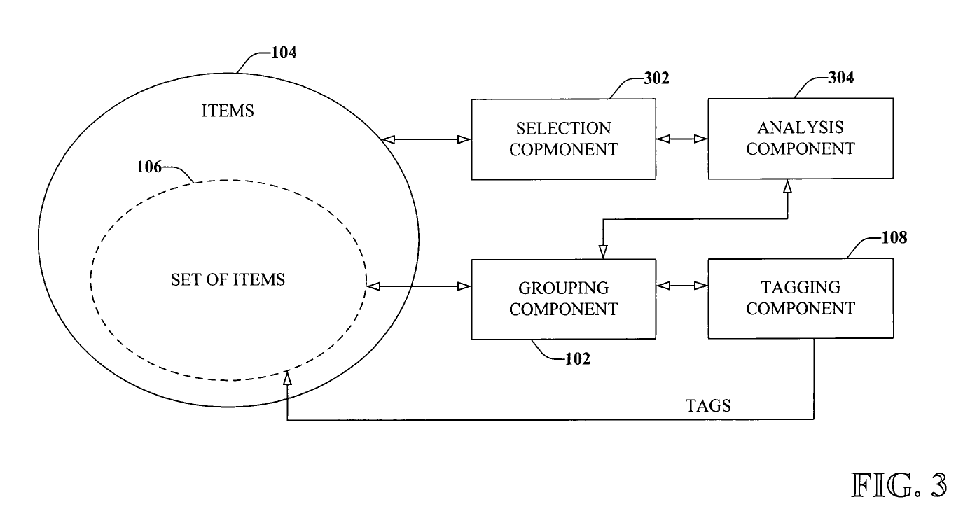

Referring now to FIG. 3, a system 300 that facilitates automatically grouping items and associating tags with one or more groups of items is illustrated. The system 300 includes a selection component 302 that is employed to select one or more items within the plurality of items 104 in connection with grouping items into a plurality of sets of related items. For example, the selection component 302 can automatically loop through each item within the plurality of items 104 in connection with grouping the items. In another example, the selection component 302 can select one or more items within the plurality of items 104 given user commands. In such an instance, the one or more items can be selected by way of a pointing and clicking mechanism, one or more keystrokes, a microphone and associated software (for receipt and implementation of voice commands), a pressure-sensitive screen, any other suitable mechanism that facilitates selection, or any combination thereof. The selection component 302 can be associated with an analysis component 304 that aids in grouping or clustering items into the set of items 106. For example, the analysis component 304 can analyze features associated with each selected item and can extract or create keywords, phrases, or other data based at least in part upon content of the selected item(s). For instance, if a selected item is a document, the analysis component 304 can extract keywords or phrases from the selected item. Pursuant to an example, a selected item can be an email, and the analysis component 304 can extract keywords or phrases from such email. Furthermore, the analysis component 304 can weight particular portions of the email in connection with extracting keywords or phrases. For instance, words or phrases that appear in a “subject” line can be provided a greater weight than words or phrases that appear in a body of a message.

In still another example, a selected item can be a digital image, and the analysis component 304 can analyze the digital image to extract features therefrom. For instance, the analysis component 304 can extract data relating to facial features of individuals from within the image, create a color chart with respect to the image, or any other suitable data analysis. Still further, alternatively or additionally to undertaking a more complex analysis of data, an analysis of other parameters associated with a selected item can be undertaken by the analysis component 304, such as name of the selected item, data and time of creation of the selected item, location of the selected item 304 within an electronic storage media, type of item, name of an individual creating the file, tags assigned to the selected item, an identity of a sender of an email, identities of other individuals in a “To” field of an email, identities of individuals in a “Cc” field, all or part of an IP address, a domain name, and any other suitable data that may be associated with items.

Results or features of an analysis undertaken by the analysis component 304 can, for example, be relayed to the grouping component 102, which can utilize such features to generate the set of related items 106 (e.g., to group items into the set of items 106). For example, the grouping component 102 can locate all items within the plurality of items 104 that have similar words in their name when compared to a selected item, were created at similar times when compared to a selected item, etc. Similarly, in an example relating to digital images, each image that includes a particular individual can be placed within the set of items 106 by the grouping component 102. Thus, the grouping component 102 can undertake any suitable operation in creating the set of items 106 based at least in part upon the analysis of selected items undertaken by the analysis component 304.

Examples are provided herein to better illustrate manners that the set of items 106 can be created. As stated above, the selection component 302 can loop through items within the plurality of items 104—in other words, each item can be analyzed by the analysis component 304, and the results of such analysis can be provided to the grouping component 102 to group items into one or more sets of related items. The selection component 302 can automatically select items in a predefined, random, and/or pseudorandom order. Furthermore, the selection component 302 can select items based upon time of creation, location of the items, name, or any other suitable manner for selecting the items. Looping through each item within the plurality of items 104 ensures that each item is associated with at least one group of items. In another example, each time that an item is selected by a user such item can be provided to the analysis component 304. Thus, a selected item will be placed within one or more groups of items.

The tagging component 108 associated with the grouping component 102 can then review the set of items 106 and associate one or more tags with the set of related items 106. For example, the tagging component 108 can utilize keyword extraction techniques to retrieve a set of keywords that can be utilized as tags with respect to each item within the set of items 106. In another example, rather than automatically tagging the items, the tagging component 108 can provide suggestions to a user by way of a graphical user interface (not shown). The user can then confirm that particular tags should be associated with each item within the set of items 106 or prevent certain tags to be associated with the set of items 106 through selection of check-boxes, for instance. Accordingly, it can be discerned that each item within the set of items 106 can be tagged without need to employ training data (e.g., a large collection of user-tags previously assigned to multiple items need not exist).

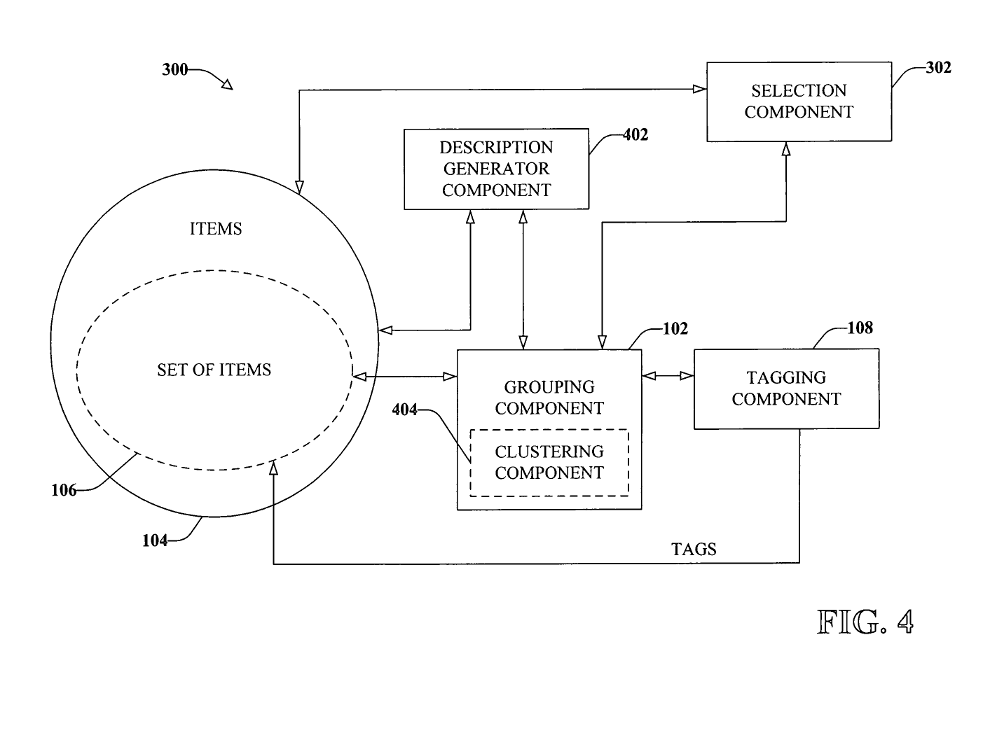

Now turning to FIG. 4, an automatic tagging system 400 is illustrated, wherein several items can be tagged simultaneously with substantially similar tags without use of training data (e.g., one or more sets of related items can be associated with at least one tag). The system 400 includes a description generator component 402 that can be employed to create a description of each item within the plurality of items 104. The description of each item can be based at least in part upon content of an item and/or relationship between the item and other items within the plurality of items 104. For instance, metadata, such as tags, can be utilized by the description generator component 402 in connection with generating a description for each of the items 104.

The system 400 further includes the selection component 302 that selects one or more items to provide to grouping component 102. The grouping component 102 can define the set of related items 106 based at least in part upon an identity of one or more selected items and the descriptions of items created by the description generator component 402. For instance, the grouping component 102 can include a clustering component 404 that can utilize an identity of a selected item and the item descriptions to cluster items within the plurality of items 104 into sets of related items, including the set of items 106. It is understood that the clustering component 404 can create a “hard” clustering. Thus, an item within one set of items would not be located within another set of items. In a different example, the clustering component 404 can perform a “soft” clustering, wherein a single item can exist in multiple sets. It can thus be determined that any suitable manner for clustering items to define one or more groups of related items is contemplated and intended to fall within the scope of the hereto-appended claims. The clustering component 404 can employ one or more clustering algorithms to effectuate grouping of items, wherein such algorithms can utilize weights associated with particular portions of the item descriptions to cluster the items. For instance, keywords or phrases in a subject line of an email message may be provided greater weight than keywords or phrases in a body of an email message.

In another use of the clustering component 404, a neighborhood or clique can be defined for each item within the plurality of items 104. Each neighborhood of items associated with one particular item can include items that are the k-nearest neighbors for the particular item. Once the selection component 302 provides one or more selected items to the grouping component 102 (selected automatically during a loop, selected by a user, or selected through any other suitable manner), the set of related items 106 can include each clique that comprises the selected item(s). If a collection of items exists in which all cliques are substantially similar, the clustering component 404 can treat or create such collection as a cluster. Thus, a combination of a k-nearest neighbor approach and one or more clustering algorithms can be employed in connection with the claimed subject matter.

The tagging component 108 can analyze the related set of items 106 and provide substantially similar tags to each item within the set of items 106. As described above, text extraction techniques can be employed in connection with determining tags to be provided to the items within the set of items 106. Thus, based upon an identity of the set of items 106 that includes, substantially similar tags can be provided to each item within such set 106. Further, tags between items within sets may not be completely identical, as at least some items may include tags provided by a user and/or associated with a disparate group of related items.

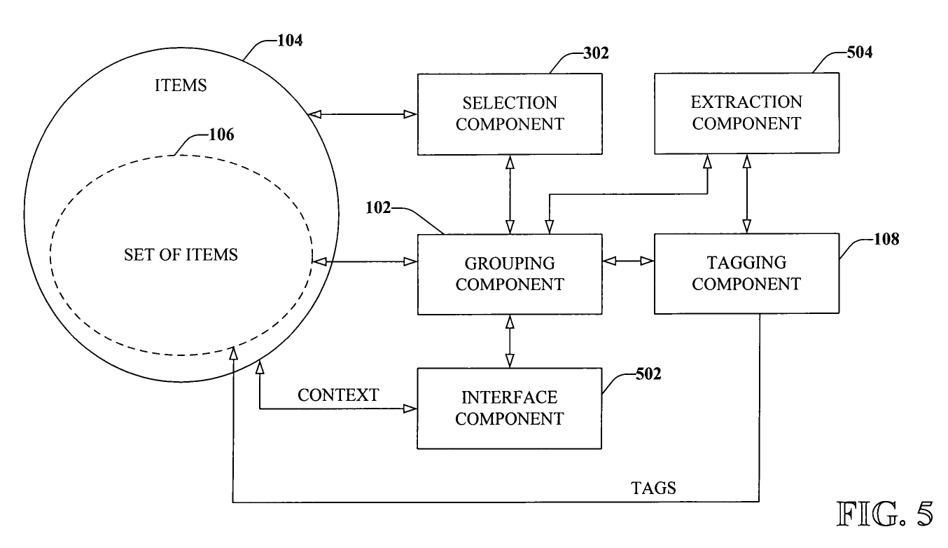

Now referring to FIG. 5, a system 500 that enables tagging of multiple, related items with substantially similar tags is illustrated. The system 500 includes the selection component 302 that selects one or more items from the plurality of items 104. For instance, the selection can be based upon user selection of items. In another example, the selection component 302 can loop through each item within the plurality of items 104, wherein other components of the system 500 (and/or systems 100, 200, 300, 400, and other systems/apparatuses described herein) can operate independently with respect to each selected item. Looping through the plurality of items can enable automatic tagging of a substantial number of items without requiring user action. An interface component 502 can be associated with the selection component 302, wherein the interface component 502 determines one or more contexts related to one or more selected items. These context(s) can be provided to the grouping component 102, which can define a set of related items for each context determined by the interface component 502. More specifically, a particular item can be grouped with disparate items depending upon a context. In another example, the interface component 502 can enable a user to select a particular context associated with a selected item. Thus, the interface component 502 can determine available contexts associated with a selected item and provide such contexts in list form (e.g., prioritized according to probability that a context is desired by a user, with the context associated with the highest probability of being desirable presented most prominently).

The interface component 502 can determine these contexts and provide them to the grouping component 102 to enable the grouping component 102 to define the set of related items 106 based upon the selected item(s) and one or more determined/selected contexts. In one particular example, a selected item can include disparate sections. Accordingly, a first context may relate to a first section while a second context may relate to a second section, and depending upon the section (selected by the user and/or according to a probability) the grouping component 102 can define disparate groups. In still another example, a selected item can be a digital image that includes images of both friends and family. A first context may be “friends” and a second context may be “family.” These contexts can be determined by the interface component 502, and the grouping component 102 can define the set of items 106 based at least in part upon a selected context. Creation of sets of related items has been described in more detail above.

Once the grouping component 102 has generated the set of related items 106, an extraction component 504 can extract features from items within the set of items 106. For example, the extraction component 504 can extract text from documents, emails, or other files that include text. In another example, the extraction component 504 can extract metadata from items, such as when an item was created, creator, sender, and/or recipient of an item, when an item was last edited, identity of an individual who last created the item, identity of one or more software applications associated with the item, and other text that may be associated with items. Still further, the extraction component 504 can extract non-textual data from items within the set of items 106. For example, a digital image may include a substantial amount of a particular color within such image, such as red. The extraction component 504 can then associate such color with the word “red,” and output such data to the tagging component 108, for example. These associations can be included within a table (not shown) or can be made through inference.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention. Thus, in one example, based at least in part upon user context (e.g., geographic location of a user, applications running on a computer, . . . ), an association between extracted data and associated text may be made.

The tagging component 108 can receive extracted and/or created text from the extraction component 504 and utilize such text in connection with selecting tags to provide to each item within the set of items 106 (e.g., which tags to associated with the set of items 106). For instance, extracted and/or created text that is common across at least some of the items within the set of items 106 can be selected by the tagging component 108 and thereafter associated with each item within the set of items 106 as tags. Pursuant to a specific example, text extracted/created by the extraction component 504 that appears a threshold number of times can be associated with each item within the set of items 106. Similarly, text extracted/created by the extraction component 404 that appears with respect to a threshold percentage of items within the set of items 106 can be utilized as tags and associated with each item within the set of items 106 by the tagging component 108.

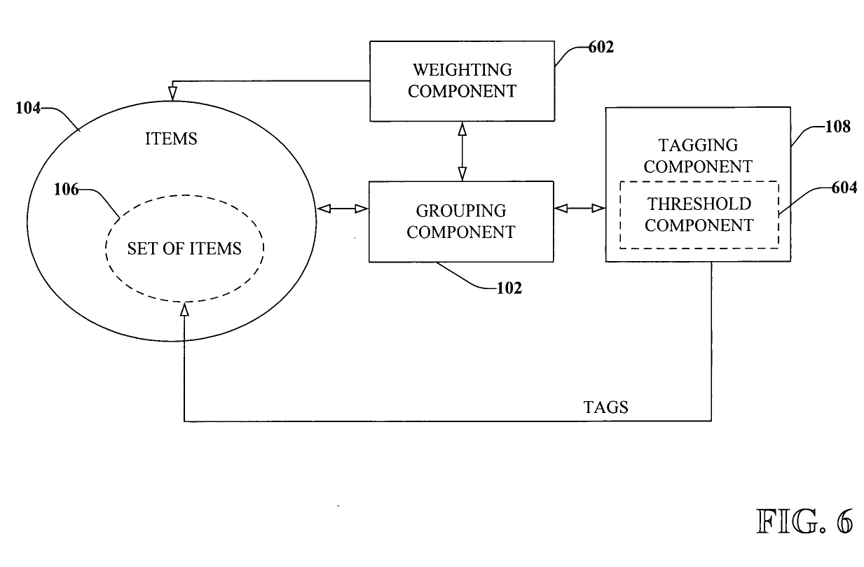

Referring now to FIG. 6, a system 600 that facilitates selective tagging of multiple items is illustrated. The system 600 includes a weighting component 602 that provides pre-defined weights to features associated with the items 104. For example, name of an item can be provided greater weight when grouping items than time of day that the item was created. Similarly, text within a subject line of an email may be provided a greater weight than text within a body of an email (or a body of a word processing document). Furthermore, the weighting component 602 can provide disparate weights with respect to relationships between different types of items. For instance, through weighting relationships, the weighting component 602 can indicate that an email and a word processing document are more likely to be related than an email and a digital image. It is understood that these examples can be extrapolated to other item types as well as other portions and/or data associated with items.

Weights provided by the weighting component 602 can be employed by the grouping component 102 in connection with defining the set of related items 106. Pursuant to an example, upon selection one or more items (not shown) the weighting component 602 can assign weights to portions of such items as well as to relationships between types of items. The grouping component 102 can analyze such weights when defining boundaries of the set of items 106. The tagging component 108 can thereafter assign substantially similar tags to each item within the set of items 106 (e.g., can provide and assign “group tags” to the items within the set 106). To ensure that items are not associated with an inordinate number of tags, the tagging component 108 can include a threshold component 604 that can be employed to limit a number of tags assigned to a particular item and/or group of items. For example, the threshold component 604 can institute a “hard” limit, such that an item may not be associated with greater than a threshold number of tags. This can be accomplished in a variety of manners, including a first in time approach, where the first threshold number of tags assigned to an item and/or group can be used, while tags provided thereafter are not associated with the item or group. In another example, a probabilistic approach can be employed, wherein tags can be assigned a probability of relatedness to an item or group of items, and a threshold number of tags associated with a highest probability can be assigned to the item or group of items. Thereafter, tags associated with the item or group can be removed if later-created tags are deemed more relevant to the item or group. User-assigned tags, however, may not count towards the threshold number of tags, as the user deems such tags to be highly related to an item or group of items.

In yet another example, the threshold component 604 can be employed to prohibit tagging of an item or set of items with tags that are not associated with a threshold probability of relatedness to the item or group of items. For instance, the threshold component 604 can impose a threshold probability or relatedness on the tagging component 108, requiring tags to be associated with at least such threshold probability prior to associating the tags with the set of items 106. Other manners similar to those described herein are also contemplated not described for sake of brevity, but are intended to fall under the scope of the hereto appended claims. The tagging component 108 can tag items within the group of items 106 so long as such tagging conforms to restrictions imposed by the threshold component 604.

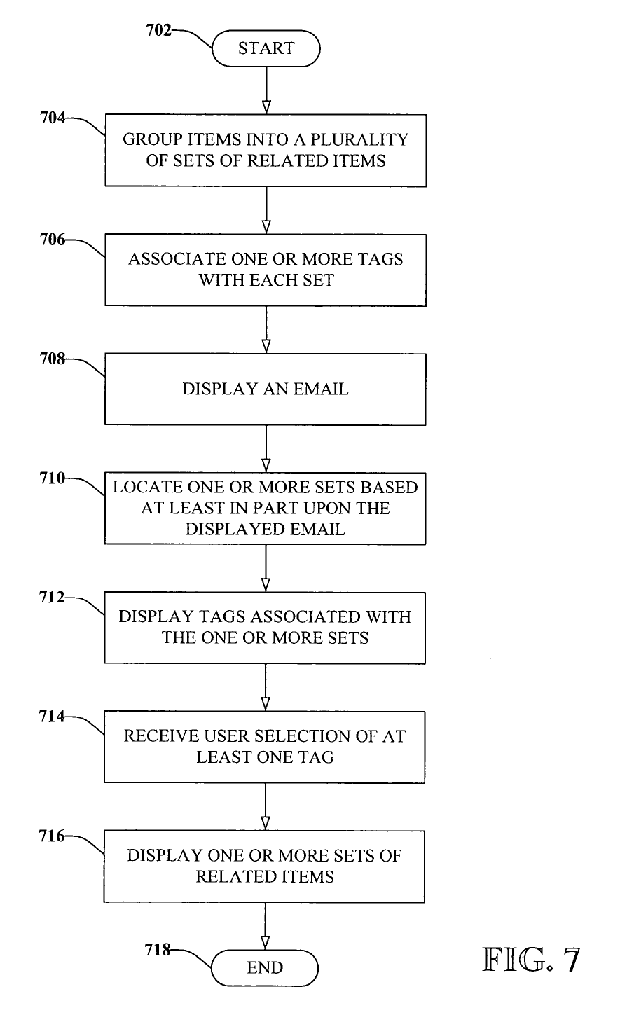

Referring now to FIGS. 7-11, methodologies in accordance with the claimed subject matter will now be described by way of a series of acts. It is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring specifically to FIG. 7, a methodology for enabling browsing of items by way of an email application is illustrated. The methodology 700 starts at 702, and at 704 items are grouped into a plurality of sets of related items. For example, clustering can be employed in connection with grouping the items into sets of related items. Furthermore, as described above, items can be assigned to one or more sets of items. It is understood, however, that any suitable manner of grouping items into sets of related items are contemplated and intended to fall within the scope of the hereto-appended claims. At 706, one or more tags are associated to each of the plurality of sets of items. These tags can be determined by analyzing item descriptions that were generated for each item. Additionally or alternatively, word graphs can be employed in connection with determining tags that are to be associated with a certain set of related items.

At 708, an email message (which is included within and/or associated with a threshold similarity to at least one set) is displayed by way of an email application. For example, the email can be displayed automatically upon opening an email application and/or upon selection of the email by the user. At 710, one or more sets of related items that include the email and/or have a threshold level of similarity with the email are located. This location can be undertaken through a comparison of tags. In other words, tags associated with the email can be compared with tags associated with the sets, thereby enabling location of the sets of related items. At 712, tags that are associated with the located sets are displayed. For instance, a field in a graphical user interface that is employed to display emails can be utilized to display selectable tags (which are associated with the located sets). Pursuant to one example, the tags can be associated with hyperlinks. At 714, a user selection is received with respect to at least one of the displayed tags. The selection can be made through use of a pointing and clicking mechanism, a pressure-sensitive screen, voice commands, and the like. At 716, one or more of the sets of located (related) items that are associated with the selected tag(s) are provided to the user upon receipt of the user selection. For instance, these items can be provided in hyperlink form so that upon selection of a hyperlink an item associated with the hyperlink can be provided to a user. This can include initiating an application, displaying an item in the graphical user interface that displays the email, etc. The methodology 700 completes at 718. While not shown, it can also be discerned that advertisements can be automatically provided upon location of the sets based at least in part upon tags associated with the sets. In another example, advertisements can be automatically displayed upon selection of a particular tag, thereby facilitating display of advertisements that are highly relevant to the user.

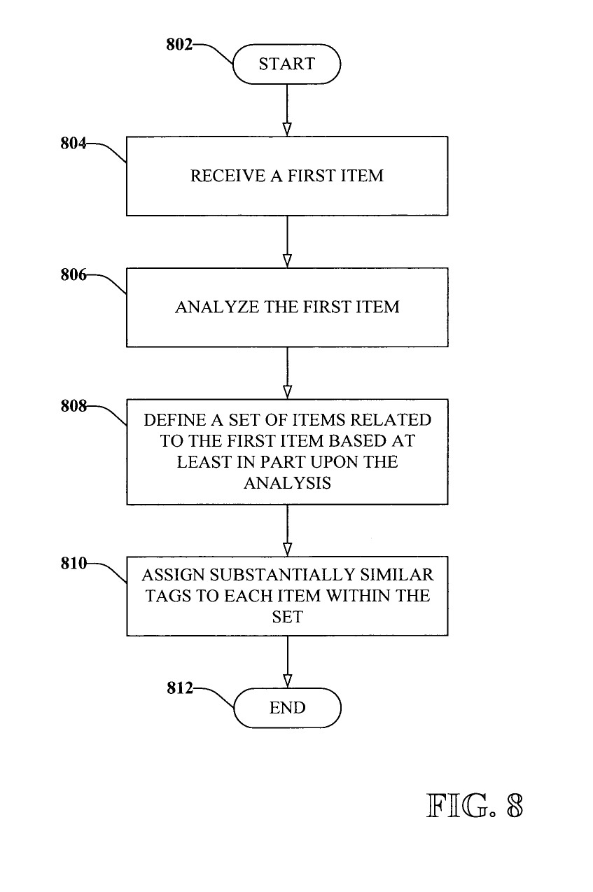

Referring specifically to FIG. 8, a methodology 800 for automatically assigning substantially similar tags to sets of related items without requirement of training data is illustrated. The methodology 800 begins at 802, and at 804 a first item is received. For instance, the item can be a word processing item, a spreadsheet item, a slide-show item, a digital image, multimedia items, such as audio and audio/video items, or any other suitable computer-executable or readable item. The first item can be received through user selection of the item and/or through an automatic selection by a computing component while stepping through a plurality of items. At 806, the first item is analyzed. For example, analysis of the first item can include analyzing a title of the item, date of creation of the item, application associated with the item, location within electronic storage of the item, tags already assigned to the item, content of the item, metadata associated with the item, and various other parameters relating to the item. It is understood, however, that this analysis need not occur later in time than the selection of the item. Rather, each item can be analyzed and a description thereof can be generated prior to selection of an item. Thus, it can be determined that order of acts in the methodology 800 is not strict and can be altered.

At 808, a set of items is defined based at least in part upon the analysis undertaken at 806, wherein items within the set of items are in some way related. For example, a clustering algorithm can be employed to cluster items into sets of related items. Furthermore, cliques or neighborhoods can be defined, wherein a clique or neighborhood includes a particular item and items that amongst k-nearest neighbors thereto. It therefore can be discerned that any suitable grouping mechanism, algorithm, and/or method can be employed in connection with defining the set of items. At 810, substantially similar tags are assigned to each of the sets of items (e.g., each item within a set of related items will be associated with similar tags, while items within a different set of related items will also be associated with similar tags (but different than those associated with the first set)). These tags can be determined through extraction of text from items within the set of items, analysis of metadata, or any other suitable manner for determining tags. After the tags are assigned to the items, a search that includes such tags would result in return of items within the set of items. The methodology 810 then completes at 812.

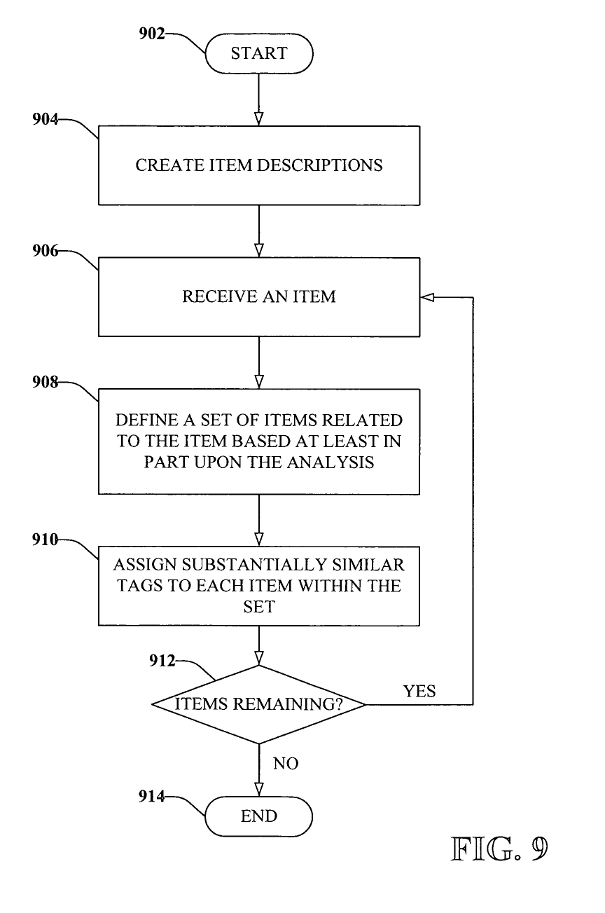

Now turning to FIG. 9, a methodology 900 for assigning substantially similar tags to items within related sets of items is illustrated. The methodology 900 begins at 902, and at 904 an item description is created for each item within a plurality of items. For instance, the item description can be created through a word graph or other similar entity. At 906, an item is received, wherein reception of such item can occur based upon an automated selection of the item within a series of items. In other words, a subset of items within the set can be automatically selected (one at a time). At 908, a set of items is defined, wherein the group includes the received item and items that are in some way related to the received item. As described above, clustering is one exemplary manner for defining the sets, but other methods are also contemplated for defining the set of items. At 910, substantially similar tags are assigned to each item within the defined set of items; therefore, searching for items is made more convenient, and does not require a user to manually attach tags to several items.

At 912, a determination is made regarding whether there are items remaining (e.g., whether each item within the set has been selected). If there are items remaining, the methodology 900 returns to act 906, where another item is received. This ensures that each item within the plurality of items will be associated with at least one set of items, and therefore will be automatically associated with tags. If there are no items remaining, the methodology ends at 914.

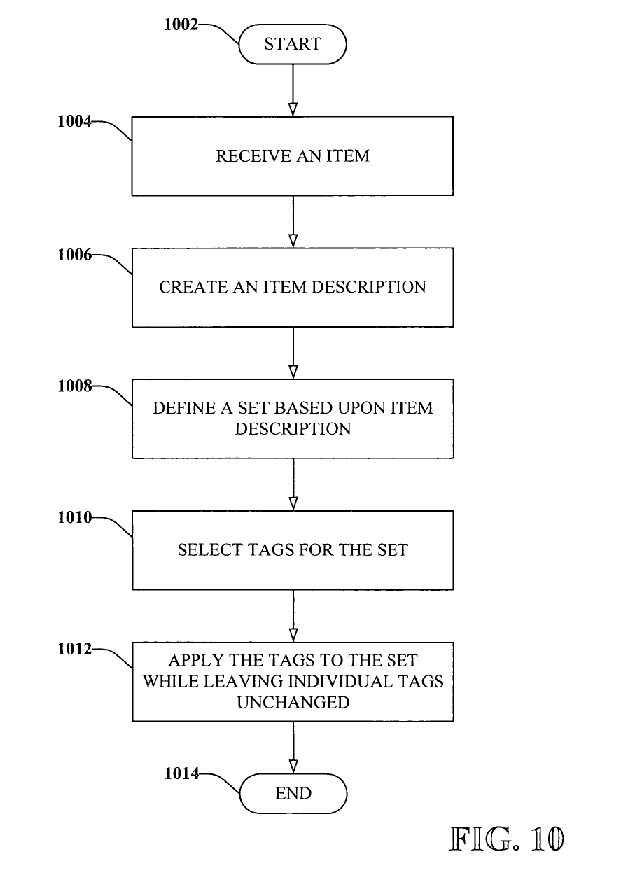

Turning now to FIG. 10, a methodology 1000 for automatically applying substantially similar tags to a set of items without need of training data is illustrated. The methodology initiates at 1002, and at 1004 an item is received, either through user selection or automatic selection. At 1006, an item description is created, wherein the description can be based upon metadata associated with the item, content of the item, and/or any other suitable data relating to the item. At 1008, a set of items is defined based upon the item description. For instance, the set can be and/or include a “clique” or “neighborhood,” which can include the received item as well as k—nearest neighbors to such item. In another example, other item descriptions can be compared to the item description associated with the received item, and through use of clustering the set can be defined.

At 1010, tags are selected for the set. Pursuant to one example, the tags can be selected by analyzing text and/or data associated with the items within the defined set of items, and thereafter selecting text and/or data that has a threshold level of commonality across items in the group. At 1012, the selected tags are applied to each item within the set of items while leaving individual tags unchanged. For instance, a user may have provided a specific tag to a certain item, and it would not be desirable to overwrite such tag with automatically created tags. The methodology 1012 then completes at 1014.

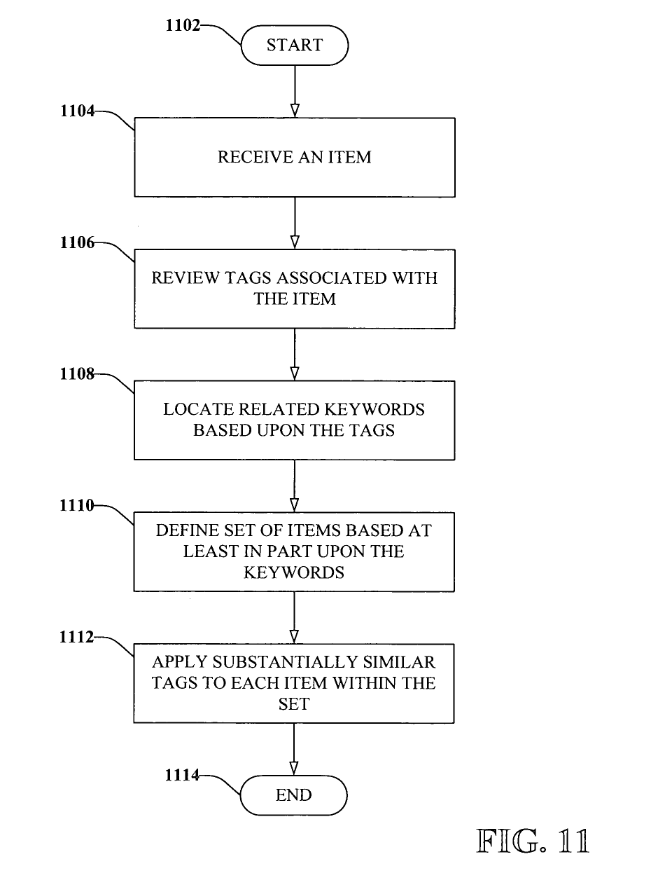

Referring now to FIG. 11, a methodology 1100 for automatic tagging of multiple items without requiring use of training data is illustrated. The methodology 1100 begins at 1102, and at 1104 an item is received. At 1106, tags that are associated with the received item are reviewed. For instance, these tags can be user assigned tags and/or tags that were previously automatically assigned to the item. At 1108, related keywords are located based at least in part upon the tags. For example, a table can be provided, wherein words are associated with one another. Thus, given a particular word, other related words (such as synonyms) can be ascertained. At 1110, a set of items is defined based at least in part upon the tags and the keywords that were ascertained from such tags. For example, each item that includes a threshold number of the tags and/or keywords can be included within the set. Similarly, items that have as tags at least some of the keywords or tags from the received item can be included within the set. At 1112, substantially similar tags can be provided to each item within the set of items. For instance, the tags may be tags associated with the item received at 1104, keywords associated thereto, tags associated with items that include one or more of the tags or keywords, etc. The methodology 1100 then completes at 1114.

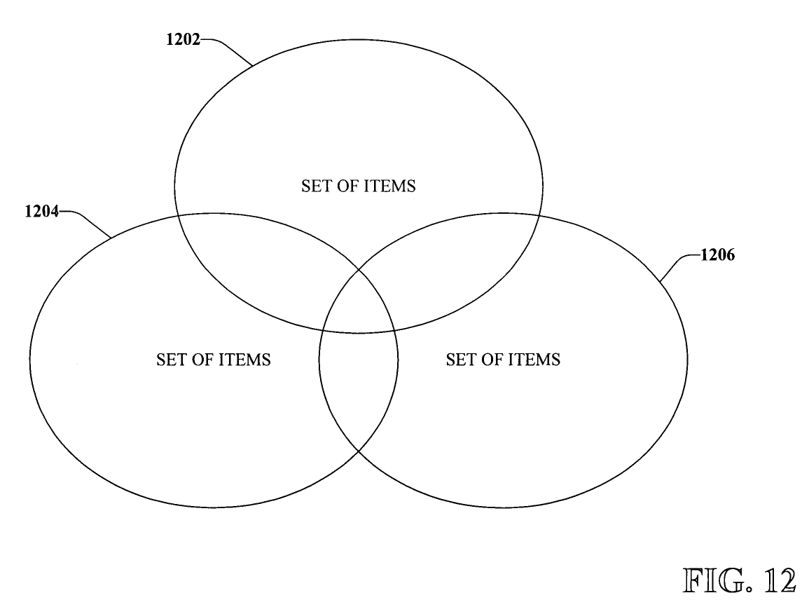

Now referring to FIG. 12, a representation 1200 of sets of related items is illustrated. The representation 1200 depicts a first set of items 1202, a second set of items 1204, and a third set of items 1206, wherein each of the sets of items include items that are related to one another. The representation 1200 is intended to illustrate that items can be associated with disparate sets of items. Thus, for example, when a plurality of items is clustered, items can lie within multiple clusters or sets. In still more detail, one or more items can be associated with each of the sets of items 1202-1206, with any combination of two sets, or can reside in a single set. It can thus be discerned that a single item may be associated with multiple sets of related items. If desirable, however, items can be confined to a single set.

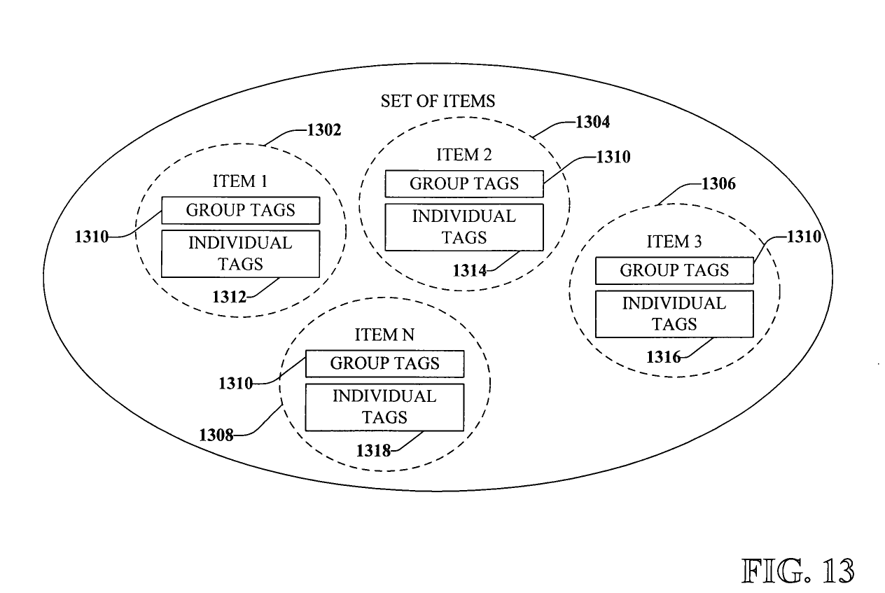

Turning now to FIG. 13, an exemplary set of related items 1300 is illustrated. The set of items 1300 includes N items, where N is greater than zero. In this particular example, the set of items 1300 comprises a first item 1302, a second item 1304, a third item 1306, and an Nth item, 1308. These items 1302-1308 have been determined to be associated with one another in some form (e.g., through clustering). Each of the items 1302-1308 includes group tags 1310, such that searching for items through use of a tag within the group tags 1310 would result in return of each of the items 1302-1308. The items can also include individual tags, such that a search for an individual tag would not result in return of each of the items within the group of items 1300. For instance, the first item 1302 can include individual tags 1312 that are dissimilar to individual tags 1314 associated with the second item 1304. Further, the third item 1306 can include individual tags 1316, and the Nth item can include individual tags 1318. Thus, each item within the group of items 1300 can include group tags as well as individual tags.

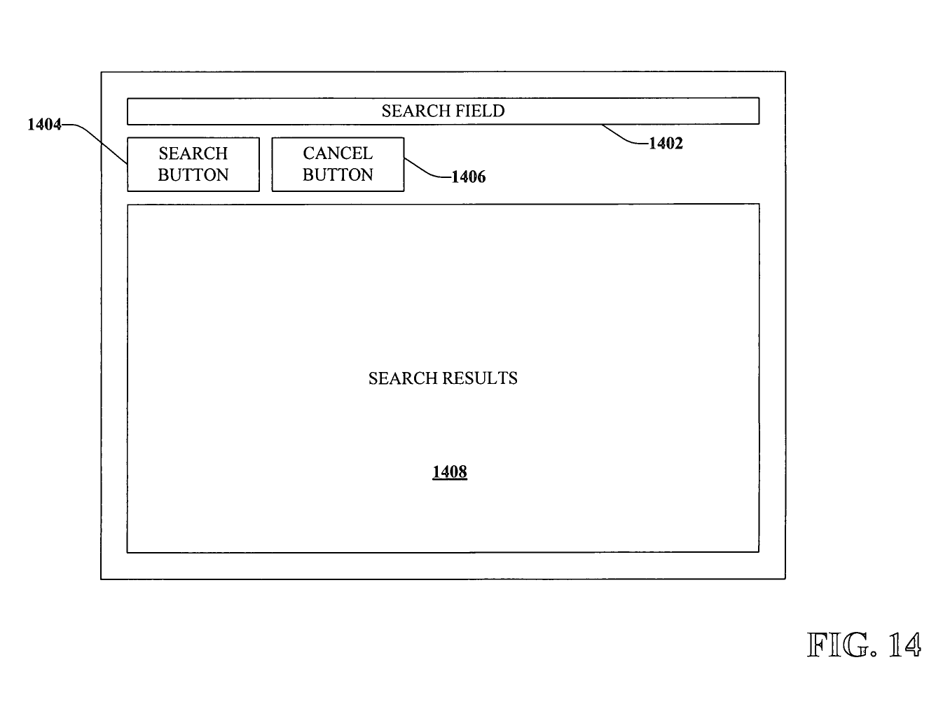

Now turning to FIG. 14, an exemplary user interface 1400 that can be employed to search for items through utilization of tags is illustrated. The user interface 1400 can include as search field 1402, wherein a user can provide text relating to an item or items that such user desires to locate. Upon entering such text, a search button 1404 can be depressed, and results of the search can be displayed in a search results field 1406. If the user wishes to cancel the search, a cancel button 1408 can be depressed (e.g., through use of a mouse). In a particular example, a user may wish to search for items relating to fishing, and thus can include the term “fishing” in the search field 1402. Upon depressing the search button 1404, the results field 1406 can display to the user each item that includes a tag entitled “fishing.” The user can then select and retrieve an item of interest.

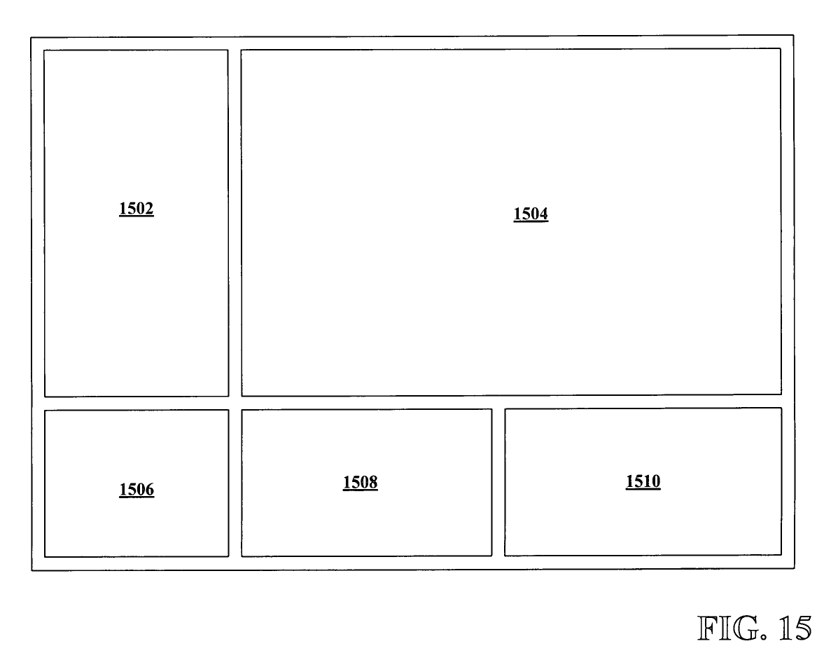

Now referring to FIG. 15, an exemplary user interface 1500 that can be employed in connection with one or more features described herein is illustrated. The user interface 1500 includes a first field 1502 that can include a list of emails, which can be organized by date received, sender, recipient(s), subject, or any other suitable manner of organization. Upon selection of at least one of the emails within the list of emails, a second field 1504 can display content of the email, including text and/or any attachments associated therewith. Upon an email being displayed, a field 1506 can display tags that are associated with the displayed email. For instance, as described above, the email can be analyzed to locate sets of items sufficiently related to such email, and tags related to the sets can be displayed in the field 1506. In one example, the tags can be hyperlinks, wherein selection of such hyperlinks causes items related with such tags to be displayed in field 1508. The items can be in list form, and selection of at least one of the items can cause an item to be displayed in the field 1504 and/or in a separate graphical user interface. Further, a field 1510 can be provided to display advertisements that are associated with the listed tags and/or associated with a selected tag or item.

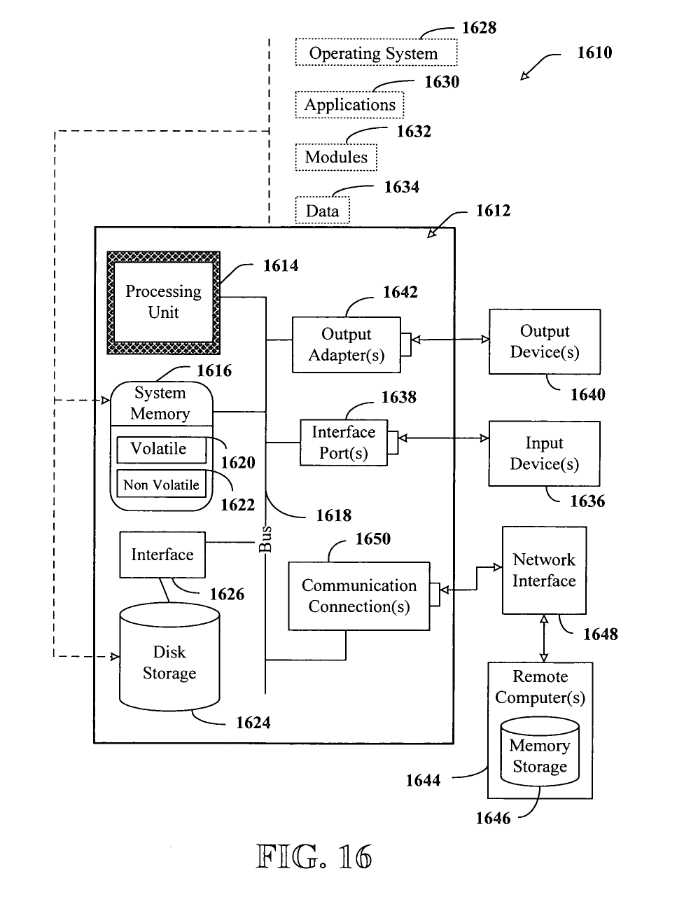

In order to provide additional context for various aspects of the subject invention, FIG. 16 and the following discussion are intended to provide a brief, general description of a suitable operating environment 1610 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. For example, these routines can relate to identifying an item and defining a group of items upon identifying such item and providing substantially similar tags to each item within the group of items. Furthermore, it is understood that the operating environment 1610 is only one example of a suitable operating environment and is not intended to suggest any limitation as to the scope of use or functionality of the claimed subject matter. Other well known computer systems, environments, and/or configurations that may be suitable for use with features described herein include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 16, an exemplary environment 1610 for implementing various aspects described herein includes a computer 1612. The computer 1612 includes a processing unit 1614, a system memory 1616, and a system bus 1618. The system bus 1618 couples system components including, but not limited to, the system memory 1616 to the processing unit 1614. The processing unit 1614 can be any of various available processors. Dual microprocessors and other multiprocessor architectures also can be employed as the processing unit 1614.

The system bus 1618 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1616 includes volatile memory 1620 and nonvolatile memory 1622. The basic input/output system (BIOS), containing the basic routines to transfer information between elements within the computer 1612, such as during start-up, is stored in nonvolatile memory 1622. By way of illustration, and not limitation, nonvolatile memory 1622 can include read only memory (ROM), programmable ROM (PROM), electrically programmable ROM (EPROM), electrically erasable ROM (EEPROM), or flash memory. Volatile memory 1620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1612 also includes removable/nonremovable, volatile/nonvolatile computer storage media. FIG. 16 illustrates, for example a disk storage 1624, which can be employed in connection with storage and retrieval of items associated with various applications. Disk storage 1624 includes, but is not limited to, devices like a magnetic disk drive, floppy disk drive, tape drive, Jaz drive, Zip drive, LS-100 drive, flash memory card, or memory stick. In addition, disk storage 1624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1624 to the system bus 1618, a removable or non-removable interface is typically used such as interface 1626.

It is to be appreciated that FIG. 16 describes software that acts as an intermediary between users and the basic computer resources described in suitable operating environment 1610. Such software includes an operating system 1628. Operating system 1628, which can be stored on disk storage 1624, acts to control and allocate resources of the computer system 1612. System applications 1630 take advantage of the management of resources by operating system 1628 through program modules 1632 and program data 1634 stored either in system memory 1616 or on disk storage 1624. It is to be appreciated that the subject invention can be implemented with various operating systems or combinations of operating systems.

A user enters commands or information into the computer 1612 through input device(s) 1636. Input devices 1636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1614 through the system bus 1618 via interface port(s) 1638. Interface port(s) 1638 include, for example, a serial port, a parallel port, a game port, and a universal serial bus (USB). Output device(s) 1640 use some of the same type of ports as input device(s) 1636. Thus, for example, a USB port may be used to provide input to computer 1612, and to output information from computer 1612 to an output device 1640. Output adapter 1642 is provided to illustrate that there are some output devices 1640 like monitors, speakers, and printers among other output devices 1640 that require special adapters. The output adapters 1642 include, by way of illustration and not limitation, video and sound cards that provide a means of connection between the output device 1640 and the system bus 1618. It should be noted that other devices and/or systems of devices provide both input and output capabilities such as remote computer(s) 1644.

Computer 1612 can operate in a networked environment using logical connections to one or more remote computers, such as remote computer(s) 1644. The remote computer(s) 1644 can be a personal computer, a server, a router, a network PC, a workstation, a microprocessor based appliance, a peer device or other common network node and the like, and typically includes many or all of the elements described relative to computer 1612. For purposes of brevity, only a memory storage device 1646 is illustrated with remote computer(s) 1644. Remote computer(s) 1644 is logically connected to computer 1612 through a network interface 1648 and then physically connected via communication connection 1650. Network interface 1648 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1650 refers to the hardware/software employed to connect the network interface 1648 to the bus 1618. While communication connection 1650 is shown for illustrative clarity inside computer 1612, it can also be external to computer 1612. The hardware/software necessary for connection to the network interface 1648 includes, for exemplary purposes only, internal and external technologies such as, modems including regular telephone grade modems, cable modems and DSL modems, ISDN adapters, and Ethernet cards.

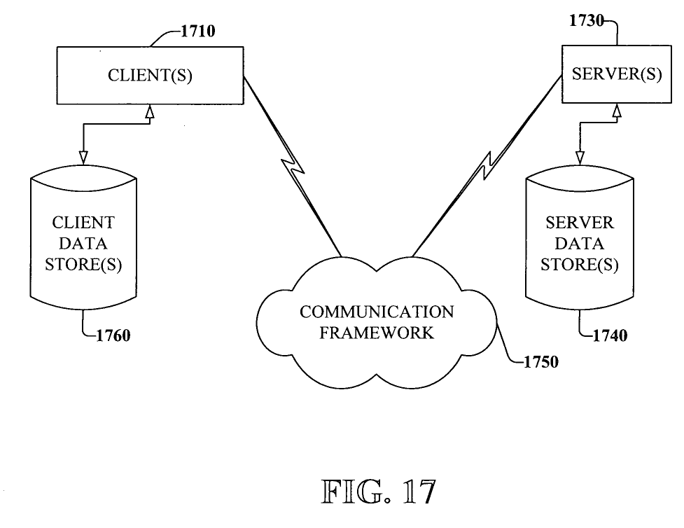

FIG. 17 is a schematic block diagram of a sample-computing environment 1700 with which the claimed subject matter can interact. The system 1700 includes one or more client(s) 1710. The client(s) 1710 can be hardware and/or software (e.g., threads, processes, computing devices). The system 1700 also includes one or more server(s) 1730. The server(s) 1730 can also be hardware and/or software (e.g., threads, processes, computing devices). The servers 1730 can house threads to perform transformations by employing various features described herein, for example. One possible communication between a client 1710 and a server 1730 can be in the form of a data packet adapted to be transmitted between two or more computer processes. The system 1700 includes a communication framework 1750 that can be employed to facilitate communications between the client(s) 1710 and the server(s) 1730. The client(s) 1710 are operably connected to one or more client data store(s) 1760 that can be employed to store information local to the client(s) 1710. Similarly, the server(s) 1730 are operably connected to one or more server data store(s) 1740 that can be employed to store information local to the servers 1730. In one example, the client(s) 1710 can include a set of items, and the server(s) 1730 can include components that are designed to provide group tags to a subset of such items.

What has been described above includes examples of the claimed subject matter. It is, of course, not possible to describe every conceivable combination of components or methodologies for purposes of describing such subject matter, but one of ordinary skill in the art may recognize that many further combinations and permutations are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for browsing items related to an email comprising the following computer-executable components:
a grouping component that groups items into a plurality of sets of related items;
a tagging component that associates one or more tags with each of the sets of related items;
an email display component that displays an email and one or more tags associated with the displayed email; and
a related item display component that receives a user selection of at least one of the one or more tags and displays one or more items related to the displayed email based at least in part upon the user selection.

2. The system of claim 1, at least one item lies in a plurality of sets of related items.

3. The system of claim 1, further comprising an advertisement display component that displays advertisements based at least in part upon the one or more displayed tags.

4. The system of claim 3, the grouping component comprises an analysis component that analyzes features of a selected item, the features are provided to the grouping component and utilized to define the sets of related items.

5. The system of claim 4, the features of the selected item include tags associated with the selected item.

6. The system of claim 4, the grouping component comprises a clustering component that clusters items to define the sets of related items.

7. The system of claim 4, further comprising a description generator component that creates a description of at least the selected item, the description is based at least in part upon one or more of content of the selected item and relationship to other items.

8. The system of claim 4, further comprising an extraction component that extracts key phrases from items within a set of related items, the extracted key phrases are employed by the tagging component in connection with associating the one or more tags to the set of related items.

9. The system of claim 4, further comprising an interface component that receives input relating to context of the selected item, the context employed by the grouping component in connection with grouping items into the plurality of sets of related items.

10. The system of claim 9, the grouping component defines disparate sets of items when given different contexts associated with the selected item.

11. The system of claim 1, the grouping component employs a k-nearest neighbor algorithm in connection with grouping the items into a plurality of sets of related items.

12. The system of claim 1, the tagging component provides substantially similar tags to items of disparate type within a set of related items.

13. The system of claim 1, the grouping component analyzes metadata associated with the items in connection with grouping the items into a plurality of sets of related items.

14. The system of claim 1, further comprising a weighting component that weights relationships between the items, the grouping component groups the items into the plurality of sets of related items based at least in part upon the weighted relationships.

15. A method for browsing items related to emails comprising the following computer-executable acts:
grouping items into a plurality of sets of related items;
associating one or more tags to each of the sets of related items;
displaying an email;
locating one or more sets of related items that at least one of include the email and have a threshold level of similarity with the email;
displaying tags that are associated with the located sets;
receiving a user selection of one or more of the displayed tags; and
displaying one or more sets of related items that are associated with the one or more selected tags.

16. The method of claim 15, further comprising displaying advertisements based at least in part upon the one or more located sets.

17. The method of claim 15, wherein at least one item resides in multiple sets of items.

18. The method of claim 15, wherein different sets of related items are associated with non-identical tag(s).

19. The method of claim 15, further comprising grouping the items by way of clustering.

20. A browsing system, comprising:
computer-implemented means for creating a set of related items;
computer-implemented means for assigning one or more tags to the set of related items;
computer-implemented means for displaying an email, the email is at least one of included within and associated with the set of related items;
computer-implemented means for displaying the one or more assigned tags based at least in part upon the displayed email; and
computer-implemented means for providing a user with items within the set of related items upon receiving a selection of at least one of the one or more assigned tags.
